(19) United States
(12) Patent Application Publication
(10) Pub. No.: US 2026/0326782 A1
(43) Pub. Date: Oct. 22, 2026

(54) Method and System for Route Planning for Automated Vehicles

(71) Applicant: Bayerische Motoren Werke Aktiengesellschaft, Muenchen (DE)

(72) Inventors: Philipp FRANECK, Muenchen (DE); Maltiza IVANOVA, Muenchen (DE); Felix REMPE, Dachau (DE)

(21) Appl. No.: 19/110,597

(22) PCT Filed: Aug. 30, 2023
(86) PCT No.: PCT/EP2023/073831

§ 371 Date: Mar. 11, 2025

(30) Foreign Application Priority Data
Sep. 12, 2022 (DE) 10 2022 123 088.0

(51) Int. Cl. B60W 60/00; B60W 30/18

(52) U.S. Cl. CPC B60W 60/001; B60W 30/18163; B60W 2552/10; B60W 2552/30; B60W 2552/53; B60W 2556/40

(57) ABSTRACT

A method includes determining a lane-accurate route from a starting point to a destination using lane-accurate map data. The determining of the track-accurate route includes determining, for a plurality of route sections between the starting point and the destination, lanes of the plurality of route sections that are suitable for automated driving. The determining of the track-accurate route includes determining the lane-accurate route taking into account the lanes of the plurality of route sections suitable for automated driving so as to maximise the time and/or distance on the lane-accurate route for automated driving.

### BACKGROUND AND SUMMARY

The present disclosure relates to a method for route planning for self-driving vehicles, to a storage medium for carrying out the method, to a system for route planning for self-driving vehicles, and to a vehicle having such a system. The present disclosure relates in particular to a lane-accurate route calculation for self-driving vehicles.

Driver assistance systems for automated driving are steadily gaining importance. Automated driving can take place with various degrees of automation. Exemplary degrees of automation are assisted, semiautomated, conditionally automated, highly automated, or fully automated driving. The above-mentioned five degrees of automation correspond to SAE levels 1 to 5 of the norm SAE J3016 (SAE—Society of Automotive Engineering) according to the status of Apr. 30, 2021. In fully automated driving (SAE level 5), all aspects of the dynamic driving task can be carried out by the system under any roadway and environmental condition which are also managed by a human driver.

Current routing systems are capable of calculating optimum routes from a starting point to a route destination and a prediction for arrival times and/or travel times rapidly and efficiently. In general, only topological properties (for example, turning links) and dynamic properties (for example, current speed, construction sites) of route sections are taken into consideration for route planning. More extensive consideration of, for example, structural conditions does not take place, which, in particular in combination with a driver assistance system for automated driving as a function of its functional embodiment, can result in inefficient route planning and/or dissatisfaction with the user of the driver assistance system.

It is an object of the present disclosure to specify a method for route planning for self-driving vehicles, a storage medium for carrying out the method, a system for route planning for self-driving vehicles, and a vehicle having such a system which enable efficient route planning for self-driving vehicles. In particular, it is an object of the present disclosure to enable maximum availability of an automated driving mode.

This object is achieved by one or more of the embodiments described herein.

According to at least one embodiment, a method is specified for route planning for self-driving vehicles, in particular motor vehicles. The method comprises determining a lane-accurate route from a starting point to a destination using lane-accurate map data, wherein determining the lane-accurate route comprises: ascertaining, for a plurality of route sections between the starting point and the destination, lanes of the plurality of route sections which are suitable for automated driving; and determining the lane-accurate route in consideration of the lanes of the plurality of route sections suitable for automated driving so as to maximize a time and/or a distance on the lane-accurate route for automated driving.

According to at least one embodiment, lane-accurate map data are taken into consideration in the route planning, such as map data having lane widths, lane markings, roadway surfaces, and/or curve radii. Based on the lane-accurate map data, it is determined for each lane of a route section whether or not automated driving is possible on the respective lane. Using this information, the route is planned in a lane-accurate manner, wherein route sections are deliberately selected for the route which have lanes suitable for automated driving. The vehicle can then travel in the lanes suitable for automated driving along the route, for example, by carrying out automatic and/or manual lane changes in multilane route sections. In this way, maximum availability of a automated driving mode can be enabled.

The term “automated driving” is understood in the context of the document as driving with automated longitudinal and/or lateral guidance. Automated driving can be, for example, driving for a longer time on the freeway or driving for a limited time in the context of parking. The term “automated driving” comprises automated driving with an arbitrary degree of automation. Exemplary degrees of automation are assisted, semiautomated, conditionally automated, highly automated, and fully automated driving (each with increasing degree of automation). The above-mentioned five degrees of automation correspond to SAE levels 1 to 5 of the norm SAE J3016 (SAE—Society of Automotive Engineering) according to the status of Apr. 30, 2021.

In assisted driving (SAE level 1), the system carries out the longitudinal or lateral guidance in specific driving situations. In semiautomated driving (SAE level 2), the system takes over the longitudinal and lateral guidance in specific driving situations, wherein the driver has to continuously monitor the system as in assisted driving. In conditionally automated driving (SAE level 3), the system takes over the longitudinal and lateral guidance in specific driving situations without the driver having to continuously monitor the system; however, the driver has to be capable within a certain time of taking over the vehicle guidance upon request by the system. In highly automated driving (SAE level 4), the system takes over the vehicle guidance in specific driving situations, even if the driver does not react to a request to intervene, so that the driver is omitted as a fallback level. In fully automated driving (SAE level 5), all aspects of the dynamic driving task can be carried out by the system under any roadway and environmental condition, which are also managed by a human driver.

In addition, the term “at least semiautomated driving or maneuvering” is also understood in the context of the document as semiautomated, conditionally automated, highly automated, fully automated driving. In other words, the term “at least semiautomated driving” is thus understood as a degree of automation from SAE level 2 inclusive.

The lane-accurate route is preferably determined using a routing algorithm.

Lanes which are suitable for automated driving are preferably ascertained based on a functional embodiment of the driver assistance system. In other words, the response to the question of whether a lane is suitable for automated driving can depend on the functional embodiment of the driver assistance system (for example, SAE level 2, 3, or 4). For example, some driver assistance systems or corresponding functional embodiments enable traveling in lanes having lesser lane width than other driver assistance systems or corresponding functional embodiments.

The plurality of route sections preferably comprises at least one multilane route section. The at least one multilane route section comprises two or more lanes for the direction of travel of the vehicle in this case. It is determined for each lane of the multilane route section whether automated driving is possible. For example, each lane of a multilane route section may not be suitable for automated driving. The route planning according to the invention selects those lanes of the multilane route sections for traveling in which optimize a time and/or a distance for automated driving.

A single route which has a plurality of route sections having at least one multilane route section can be possible between the starting point and the destination. The route planning according to the invention selects for the route that lane of the at least one multilane route section for traveling in which optimizes a time and/or a distance for automated driving.

In some embodiments, a plurality of routes can be possible between the starting point and the destination, wherein each route of the plurality of routes has a plurality of route sections. The plurality of routes can have at least partially different route sections in this case. The route planning according to the invention selects from the plurality of routes that route which optimizes a time and/or a distance for automated driving.

The lane-accurate map data preferably comprise one or more lane-accurate attributes. The one or more lane-accurate attributes can be selected from the group which comprises or consists of lane types, lane widths, lane markings, roadway surfaces, curve radii, and construction sites.

The method preferably furthermore comprises determining, based on the one or more lane-accurate attributes, the lanes suitable for automated driving. A functional embodiment of the driver assistance system (for example, SAE level 2, 3, or 4) can be taken into consideration here. In other words, the response to the question of whether a lane is suitable for automated driving can depend on the functional embodiment of the driver assistance system. For example, some driver assistance systems or corresponding functional embodiments enable traveling in lanes having lesser lane width than other driver assistance systems or corresponding functional embodiments.

The determined lane-accurate route preferably comprises geo-positions, in particular high-accuracy geo-positions and/or GPS positions. The geo-positions specify the lane(s) suitable for automated driving on the lane-accurate route. The vehicle uses the geo-positions to travel in the lane. In other words, the geo-positions can be used for lane-accurate traveling of the route.

The geo-positions preferably specify a center of the at least one lane suitable for automated driving. The vehicle can therefore travel centrally in the lane or along a (virtual) centerline.

Alternatively, the geo-positions can deviate to the left or right from the center of the lane with respect to the direction of travel of the vehicle. In particular, the vehicle can drive on a left lane boundary or right lane boundary (or closer to a left or right lane boundary than to a right or left lane boundary, respectively), for example, to form an emergency lane.

In addition to the geo-positions, in some embodiments a tolerance range can be determined or specified for the lane-accurate route, which describes a possible driving tube of the vehicle within which it can be driven.

The method preferably comprises determining at least one lane change which is necessary so that the vehicle travels in the lane(s) suitable for automated driving along the lane-accurate route. In particular, the at least one lane change can take place on a multilane route section having two or more lanes for the direction of travel of the vehicle. It can thus be ensured that the optimum lane is always used on a multilane route section, so that a time and/or a distance for automated driving can be optimized.

In some embodiments, the method comprises carrying out the at least one lane change in an automated manner by the self-driving vehicle. In particular, the vehicle can take over lateral guidance of the vehicle to change the lane automatically.

In some embodiments, the method comprises outputting a driver notification to a driver of the vehicle for the at least one lane change to be carried out manually by the driver. In particular, the vehicle can prompt the driver to change the lane manually. For this purpose, it is possible in some embodiments to change temporarily from an automated driving mode into a manual driving mode, in order to enable the manual lane change for the driver. This can take place, for example, in situations in which the functional embodiment of the driver assistance system does not permit an automated lane change (for example, SAE level 2).

The vehicle preferably comprises at least one output device to output the driver notification. The at least one output device can comprise at least one display device and/or at least one loudspeaker. The at least one display device can comprise a display, in particular an LCD display, a plasma display, or an OLED display. Additionally or alternatively, the at least one display device can comprise a projection device configured to insert information directly into the field of view of the driver, in particular to project it on a windshield. In some embodiments, the at least one output device can be a central information output device of an infotainment system, such as a head unit or a pillar-to-pillar display. The at least one output device is preferably permanently installed in the vehicle.

The method preferably furthermore comprises capturing, by way of a surroundings sensor system of the vehicle, surroundings data; and carrying out lane-accurate automated driving along the lane-accurate route based on the surroundings data. The surroundings data or a corresponding sensor-based surroundings model of the vehicle can therefore form an influencing factor, for example to prevent collisions of the vehicle with objects or other road users.

The vehicle preferably comprises a surroundings sensor system configured to capture the surroundings data. The surroundings sensor system preferably comprises at least one lidar system and/or at least one radar system and/or at least one camera and/or at least one ultrasound system and/or at least one laser scanner. The surroundings sensor system can provide the surroundings data (also referred to as “environmental data”), which depict a surrounding area of the vehicle.

The method preferably furthermore comprises actuating the self-driving vehicle such that the vehicle follows the lane-accurate route. In particular, the vehicle can follow the lane-accurate route in that the vehicle compares its current position with the planned position and adapts the steering and/or speed.

The method preferably furthermore comprises providing the lane-accurate route for a simulation for safeguarding a driver assistance system for automated driving. To safeguard driving functions for automated driving, there is the necessity of traveling the routes by means of simulation and endurance run journeys. The lane-accurate routes ascertained using the method according to the invention can be used for lane-accurate safeguarding of the driving functions and therefore permit, for example, autonomous lane changes to be carried out on the lane-accurate routes, by which a level of user-friendliness of the driving functions is improved.

According to at least one embodiment, a software (SW) program is specified. The SW program can be configured to be executed on one or more processors and to thus carry out the method for route planning for self-driving vehicles described in this document.

According to at least one embodiment, a storage medium is specified. The storage medium can comprise an SW program which is configured to be executed on one or more processors, and to thus carry out the method for route planning for self-driving vehicles described in this document.

According to at least one embodiment, software having program code is specified. The software is configured to carry out the method for route planning for self-driving vehicles when the software runs on one or more software-controlled devices.

According to at least one embodiment, a system for route planning for self-driving vehicles is specified. The system comprises one or more processors; and at least one memory, which is connected to the one or more processors and contains instructions which can be executed by the one or more processors in order to carry out the method for route planning for self-driving vehicles described in this document.

The system is configured in particular to carry out the method for route planning for self-driving vehicles described in this document. The method can implement the aspects of the system described in this document.

A processor or a processor module is a programmable arithmetic unit, thus a machine or an electronic circuit, which controls other elements according to transferred commands and drives an algorithm (process) forward in this case.

The system is preferably a driver assistance system for automated driving or is at least partially comprised in such a driver assistance system or is communicatively connected to the driver assistance system.

Preferably, the entire system is integrated in the vehicle. The present disclosure is not limited thereto, however, and parts of the system or the entire system, such as a routing module for the route planning according to the invention, can be implemented outside the vehicle, for example, in a central unit or a backend. In this case, a communication connection can be present between the vehicle and the central unit in order to transmit the lane-accurate route to the vehicle and to enable the functionalities of the driver assistance system described in this document. The communication connection can be implemented, for example, by means of a mobile network, such as an LTE network or 5G network.

According to at least one embodiment, a vehicle, in particular a motor vehicle, is specified. The vehicle comprises the system for route planning for self-driving vehicles and/or a driver assistance system for automated driving according to the embodiments of the present disclosure.

The term vehicle comprises passenger vehicles, trucks, buses, caravans, motorcycles, etc. which are used to convey people, goods, etc. In particular, the term comprises motor vehicles for conveying people.

Exemplary embodiments of the disclosure are shown in the figures and will be described in more detail hereinafter.

### BRIEF DESCRIPTION OF THE DRAWINGS

FIG. 1 schematically shows a vehicle having a driver assistance system for automated driving according to embodiments of the present disclosure, and

FIG. 2 shows a flow chart of a method for route planning for self-driving vehicles according to embodiments of the present disclosure.

### DETAILED DESCRIPTION OF THE DRAWINGS

Identical reference signs are used hereinafter for identical and identically acting elements, if not indicated otherwise.

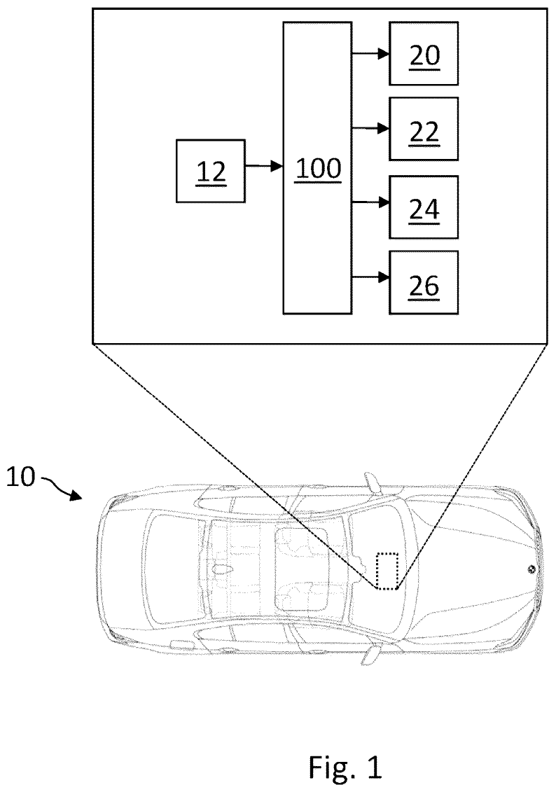

FIG. 1 schematically shows a vehicle 10 having a driver assistance system 100 for automated driving according to embodiments of the present disclosure.

In automated driving, the longitudinal and/or lateral guidance of the vehicle 10 takes place automatically. The driver assistance system 100 thus takes over the vehicle guidance. For this purpose, the driver assistance system 100 controls the drive 20, the transmission 22, the hydraulic service brake 24, and the steering system 26 via intermediate units (not shown).

To plan and carry out the automated driving, surroundings information from a surroundings sensor system, which observes the vehicle surroundings, is received by the driver assistance system 100. In particular, the vehicle can comprise at least one surroundings sensor 12 configured to record surroundings data which specify the vehicle surroundings. The at least one surroundings sensor 12 can comprise, for example, one or more lidar systems, one or more radar systems, one or more laser scanners, one or more ultrasonic sensors, and/or one or more cameras.

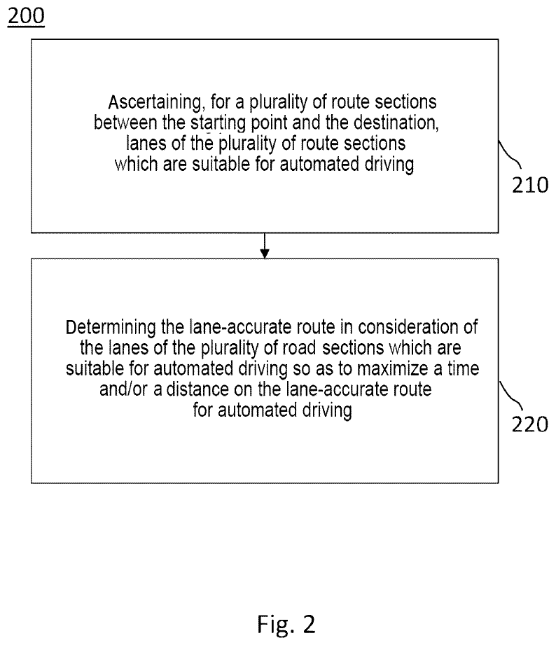

FIG. 2 schematically shows a flow chart of a method 200 for route planning for self-driving vehicles according to embodiments of the present disclosure. The method 200 can be implemented by corresponding software which is executable by one or more processors (such as a CPU).

The method 200 determines a lane-accurate route from a starting point to a destination using lane-accurate map data. The determination of the lane-accurate route comprises, in block 210, ascertaining, for a plurality of route sections between the starting point and the destination, lanes of the plurality of route sections which are suitable for automated driving; and, in block 220, determining the lane-accurate route in consideration of the lanes of the plurality of route sections suitable for automated driving so as to maximize a time and/or a distance on the lane-accurate route for automated driving.

The method 200 can be implemented by a routing algorithm, which calculates routes such that the vehicle can remain as long as possible and without interruption in the automated driving mode. For this purpose, the method 200 uses attributes of a digital map in combination with the technical embodiment of the available driving function, and optionally a list of actions which the vehicle and/or the driver has to carry out.

Actions can comprise required manual and/or autonomous lane changes to the optimum lane, preconditioning of the vehicle in automated driving operation, etc. The attributes used for the route calculation of the digital map comprise lane-accurate attributes for the construction of lane-accurate routes, such as lane widths, lane markings, vehicle surfaces (potholes, coefficients of friction, etc.), curve radii, and/or construction sites.

The result of the routing algorithm is a list of high-accuracy geo-positions on a lane of a suitable route section. The positions on the roadway can be located centered in the center of the lane, or also deviate toward the right or left edge. The variation within the lane helps to avoid objects and/or form emergency lanes. In addition to the high-accuracy position, a tolerance range can additionally be specified for the route, which describes the possible driving tube of the vehicle within which it can be driven.

The lane-accurate route can be transmitted to the real self-driving vehicle and/or a simulation (virtual vehicle). The real/virtual vehicle follows the predetermined route in that the vehicle compares its current position with the planned position and adapts steering and/or speed. An influencing factor can moreover be a sensor-based surroundings model of the vehicle which prevents collisions of the vehicle with objects and other road users.

According to the invention, lane-accurate map data are taken into consideration in the route planning, such as map data having lane widths, lane markings, roadway surfaces, and/or curve radii. Based on the lane-accurate map data, it is determined for each lane of a route section whether or not automated driving is possible on the respective lane. The route is planned in a lane-accurate manner using this information, wherein route sections are deliberately selected for the route which have lanes suitable for automated driving. The vehicle can then travel in the lanes suitable for automated driving along the route, for example by carrying out automatic and/or manual lane changes in multilane route sections. In this way, maximum availability of an automated driving mode can be enabled.

Although the invention was illustrated and explained in more detail by preferred exemplary embodiments, the invention is not restricted by the disclosed examples and other variations can be derived therefrom by a person skilled in the art without leaving the scope of protection of the invention. It is therefore clear that a plurality of possible variations exists. It is also clear that embodiments mentioned by way of example actually only represent examples, which are not to be interpreted in any way as a limitation of, for example, the scope of protection, the possible applications, or the configuration of the invention. Rather, the preceding description and the description of the figures make a person skilled in the art capable of specifically implementing the exemplary embodiments, wherein a person skilled in the art, aware of the disclosed concept of the invention, can perform a variety of changes, for example, with respect to the function or the arrangement of individual elements mentioned in an exemplary embodiment without leaving the scope of protection defined by the claims and their legal equivalents, such as more extensive explanations in the description.

1-10. (canceled)

11. A method for route planning for self-driving vehicles, comprising:
determining a lane-accurate route from a starting point to a destination using lane-accurate map data, wherein determining the lane-accurate route comprises:
ascertaining, for a plurality of route sections between the starting point and the destination, lanes of the plurality of route sections which are suitable for automated driving, and
determining the lane-accurate route in consideration of the lanes of the plurality of route sections which are suitable for automated driving so as to maximize a time and/or a distance on the lane-accurate route for automated driving.

12. The method of claim 11, wherein:
lanes which are suitable for automated driving are ascertained based on a functional embodiment of a driver assistance system for automated driving; and/or
the plurality of route sections comprises at least one multilane route section, and it is determined for each lane of the multilane route section whether automated driving is possible.

13. The method of claim 11,
wherein the lane-accurate map data comprise one or more lane-accurate attributes, wherein the one or more lane-accurate attributes are selected from the group consisting of lane types, lane widths, lane markings, roadway surfaces, curve radii, and construction sites, and
wherein the method further comprises: determining, based on the one or more lane-accurate attributes, the lanes suitable for automated driving.

14. The method of claim 11,
wherein the determined lane-accurate route comprises geo-positions,
wherein the geo-positions specify a center of at least one lane suitable for automated driving on the lane-accurate route or deviate to the left or right from the center.

15. The method of claim 11, further comprising:
determining at least one lane change necessary so that the vehicle travels in the lanes suitable for automated driving along the lane-accurate route; and
carrying out the at least one lane change in an automated manner by way of the self-driving vehicle; or
outputting a driver notification to a driver of the vehicle to manually carry out the at least one lane change by way of the driver.

16. The method of claim 11, further comprising:
acquiring, via a surroundings sensor system of the vehicle, surroundings data; and
carrying out lane-accurate automated driving along the lane-accurate route based on the surroundings data.

17. The method (200) of claim 11, further comprising:
actuating the self-driving vehicle such that the vehicle follows the lane-accurate route; and/or
providing the lane-accurate route for a simulation for safeguarding a driver assistance system for automated driving.

18. A non-transitory computer readable medium storing instructions that when executed by a processer causes a self-driving vehicle to carry out the method of claim 11.

19. A system for route planning for self-driving vehicles, comprising:
one or more processors; and
at least one memory connected to the one or more processors and storing processor executable instructions to carry out the method of claim 11.

20. A motor vehicle comprising the system of claim 19.
